(19) United States
(12) Patent Application Publication
(10) Pub. No.: US 2015/0267909 A1
(43) Pub. Date: Sep. 24, 2015

(54) ILLUMINATING DEVICE

(71) Applicant: KABUSHIKI KAISHA TOSHIBA, Minato-ku (JP)

(72) Inventors: Tomoyuki SUZUKI, Kawasaki (JP); Hiroshi Ohno, Yokohama (JP); Katsumi Hisano, Matsudo (JP); Tomonao Takamatsu, Kawasaki (JP); Mitsuaki Kato, Kawasaki (JP)

(73) Assignee: KABUSHIKI KAISHA TOSHIBA, Minato-ku (JP)

(21) Appl. No.: 14/640,435

(22) Filed: Mar. 6, 2015

(30) Foreign Application Priority Data
Mar. 19, 2014 (JP) 2014-056401

(51) Int. Cl. F21V 29/74; F21V 5/04; F21V 13/04; F21K 99/00; F21V 29/83

(52) U.S. Cl. CPC F21V 29/74; F21K 9/135; F21K 9/50; F21V 29/83; F21V 13/04; F21V 5/04; F21Y 2101/02

(57) ABSTRACT

According to one embodiment, an illuminating device comprises a base member including a first surface on which light-emitting elements are held, a second surface opposite to the first surface, and a through hole connecting the first surface and the second surface to each other, an optical lens arranged to be opposed to the light-emitting elements on the first surface side of the base member, and a heat dissipation member arranged in thermal contact with the base member on the second surface side of the base member. The optical lens includes a ventilation flue configured to introduce outside air into the through hole. The heat dissipation member comes into contact with the outside air to be introduced through the ventilation flue and the through hole to carry out heat exchange, thereby radiating heat generated from the light-emitting elements.

### CROSS-REFERENCE TO RELATED APPLICATION

This application is based upon and claims the benefit of priority from Japanese Patent Application No. 2014-056401, filed Mar. 19, 2014; the entire contents of which are incorporated herein by reference.

### FIELD

Embodiments described herein relate generally to an illuminating device provided with a heat radiating function.

### BACKGROUND

In recent years, an LED bulb using a light-emitting diode (LED) is developed. An LED is generally vulnerable to heat, and hence requires a structure for heat dissipation. As a heat dissipation structure of an LED bulb, for example, a structure in which fins are provided on an outer surface of the bulb main body is known. However, when such a heat dissipation structure is employed, the size of the bulb becomes large, and the appearance is ugly.

For this reason, an LED bulb provided inside with a structure configured to cause a cooling wind to flow is developed.

However, when a cooling wind is caused to flow inside the bulb, the LED becomes dirty with dust, and the luminous efficiency thereof is lowered. Further, the structure (fins or the like) for heat dissipation provided inside the bulb absorbs light of the LED to thereby form a shadow.

Accordingly, development of an LED bulb having high luminous efficiency, and excellent heat dissipation properties is desired.

### BRIEF DESCRIPTION OF THE DRAWINGS

FIG. 1 is a partially-cutaway perspective view of an LED bulb according to a first embodiment.

FIG. 2 is a cross-sectional view showing the LED bulb of FIG. 1.

FIG. 3 is a cross-sectional view obtained by cutting an LED bulb according to a second embodiment along a bulb axis thereof.

FIG. 4 is a partially enlarged cross-sectional view for explaining an example in which part of an optical lens of FIG. 2 is brought into contact with a base member.

FIG. 5 is an external view showing a first modification example of the first and second embodiments.

FIG. 6 is an external view showing a second modification example of the first and second embodiments.

FIG. 7 is an external view showing a third modification example of the first and second embodiments.

FIG. 8 is a partially enlarged cross-sectional view showing an example in which fins of the first and second embodiments are brought into contact with a cover member.

FIG. 9 is a partially enlarged cross-sectional view showing an example in which a gap is provided between each of the fins of the first and second embodiments, and cover member.

FIG. 10 is a view showing an example of a conventional LED bulb.

FIG. 11 is a cross-sectional view showing a modification example of the LED bulb of FIG. 3.

FIG. 12 is a perspective view showing a state where a cover member of the LED bulb of FIG. 11 is divided.

FIG. 13 is a perspective view for explaining a mounting structure of fins of the LED bulb of FIG. 11.

### DETAILED DESCRIPTION

According to one embodiment, an illuminating device comprises a base member including a first surface on which light-emitting elements are held, a second surface opposite to the first surface, and a through hole connecting the first surface and the second surface to each other, an optical lens arranged to be opposed to the light-emitting elements on the first surface side of the base member, and a heat dissipation member arranged in thermal contact with the base member on the second surface side of the base member. The optical lens includes a ventilation flue configured to introduce outside air into the through hole. The heat dissipation member comes into contact with the outside air to be introduced through the ventilation flue and the through hole to carry out heat exchange, thereby radiating heat generated from the light-emitting elements.

Various embodiments will be described hereinafter with reference to the accompanying drawings. It should be noted that in the following description, configurations which function identically in each of the embodiments (and modification examples) are denoted by identical reference symbols.

### First Embodiment

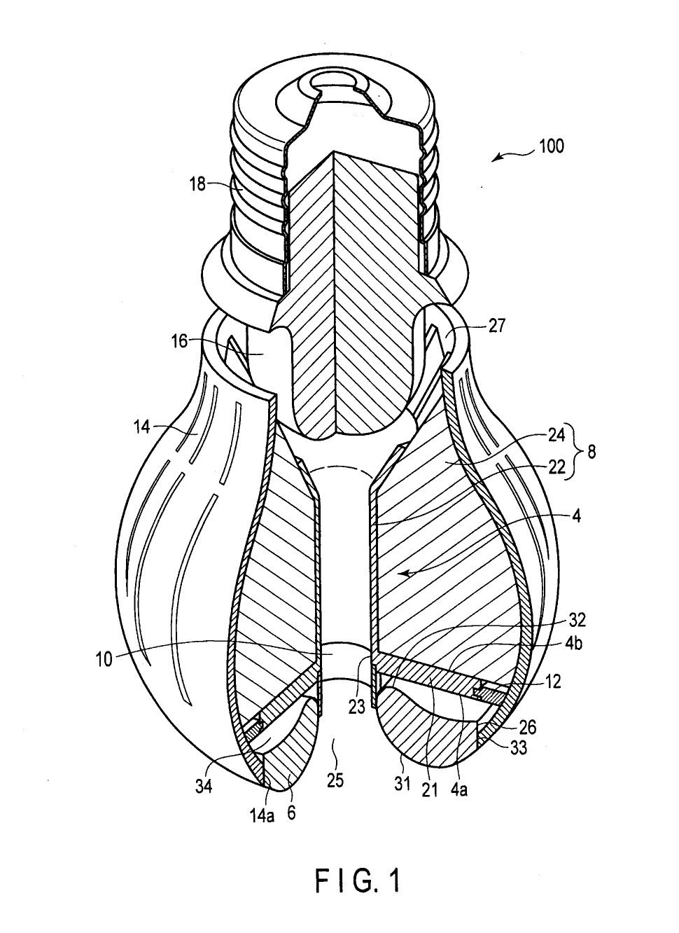

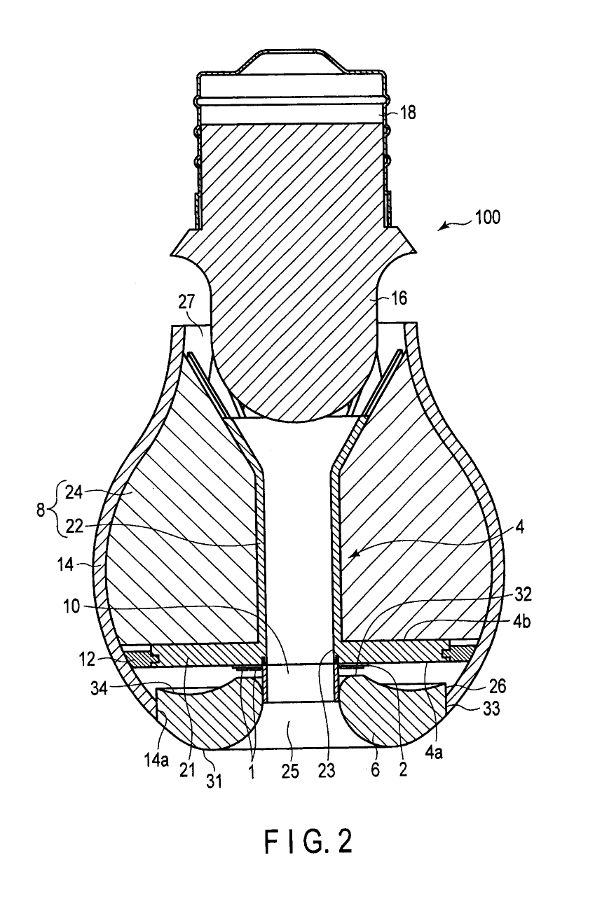

FIG. 1 is a partially-cutaway perspective view of an LED bulb 100 which is a first embodiment of an illuminating device, and FIG. 2 is a cross-sectional view obtained by cutting the LED bulb 100 into halves along a bulb axis thereof.

The LED bulb 100 of this embodiment includes an annular substrate 2 on which a plurality of light-emitting elements 1 are mounted, base member 4 including a surface 4a (first surface) on which the substrate 2 is mounted in such a manner that a back of the substrate 2 is in contact with the surface 4a, optical lens 6 arranged in opposition to the light-emitting elements on the surface 4a side of the base member 4, and heat dissipation member 8 arranged on the back 4b (second surface) side of the base member 4. Further, the LED bulb 100 includes, in addition to the above-mentioned components, a cylinder member 10, transparent member 12, cover member 14, power supply section 16, and base 18.

The base member 4 includes an annular base plate 21, and long cylinder 22 which are formed integral with each other. The base plate 21 includes a circular through hole 23 connecting the surface 4a, and back 4b to each other in the center thereof. The long cylinder 22 is approximately cylindrical, and one end (lower end in FIG. 1 or FIG. 2) thereof is integrally joined to the inner circumference of the through hole 23 of the base plate 21. That is, an inner diameter of the through hole 23, and an inner diameter of the long cylinder 22 are identical to each other. The other end (upper end in FIG. 1 and FIG. 2) of the long cylinder 22 is radially spread. The base member 4 has a rotationally symmetric form around the bulb axis of the LED bulb 100.

On the back 4b side of the base plate 21, and on the outer side of the long cylinder 22, a plurality of plate-like fins 24 are provided radially around the bulb axis. One end side (lower end side in FIG. 1 and FIG. 2) of each of the fins 24 is in contact with the back 4b of the base plate 21. Further, the other end side (inner end side) adjacent to this end side of each fin 24 is in contact with the outer surface of the long cylinder 22. That is, each fin 24 is in thermal contact with the base plate 21, and long cylinder 22 of the base member 4.

Further, still the other end side of each fin 24 is outwardly inclined along the other end of the long cylinder 22. Further, the remaining end side of each fin 24 is curved along the inner surface of the cover member 14 to be in contact with the cover member 14.

The annular-plate like transparent member 12 is provided between an outer circumferential edge of the base plate 21 of the base member 4, and the inner surface of the cover member 14. That is, the base plate 21, and the transparent member 12 separate the space inside the bulb body of the LED bulb 100 into two sections in the bulb axis direction.

The long cylinder 22 of the base member 4, and the plurality of fins 24 function as the heat dissipation member 8. That is, heat emitted from the plurality of light-emitting elements 1 is transmitted to the base plate 21 of the base member 4 through the substrate 2, and then is radiated through the long cylinder 22, and plurality of fins 24. At this time, the heat is transmitted also to the cover member 14 through the plurality of fins 24. Each fin 24, and the transparent member 12 are not in contact with each other.

The optical lens 6 includes, in the center thereof, an opening section 25 functioning as a ventilation flue configured to introduce outside air into the above-mentioned through hole 23 of the base member 4. The optical lens 6 includes a curved surface 31 gently continued from the outer surface of cover member 14 in such a manner that the surface 31 constitutes part of the outer surface of the bulb. The inner part of the curved surface 31 is gently continued on the inner surface of the opening section 25. Further, the optical lens 6 includes an annular flat incidence plane 32 continued from the curved surface 31, and opposed to the plurality of light-emitting elements 1 arranged around the through hole 23. Further, the optical lens 6 includes an exit plane 33 along the bulb axis at an outer circumferential edge thereof. Furthermore, the optical lens 6 includes a reflection concave 34 configured to guide light incident on the incidence plane 32 to the exit plane 33 by causing the light to give rise to total reflection between the incidence plane 32, and curved surface 31. That is, the surface of the optical lens 6 is a surface formed by continuously connecting the curved surface 31, incidence plane 32, exit plane 33, and reflection concave 34 to each other.

The cylinder member 10 is a relatively short cylinder, and is arranged inside the opening section 25 of the optical lens 6. The inner diameter of the cylinder member 10 is also identical to the inner diameter of the base member 4. It should be noted that the diameter of the opening section present in the center of the substrate 2 is slightly larger than the outer diameter of the cylinder member 10. One end (upper end in FIG. 1 and FIG. 2) of the cylinder member 10 abuts on the surface 4a of the base plate 21 of the base member 4. The outer surface of the cylinder member 10 is in contact with the inner surface of the opening section 25 of the optical lens 6. Further, part of the exit plane 33 of the optical lens 6 is in contact with the end face 14a of the cover member 14. The exit plane 33 of the optical lens 6 is provided with a step section 26 not in contact with the cover member 14.

The curved surface 31 of the optical lens 6 has a streamlined shape not only capable of causing light to give rise to total reflection, but also capable of smoothly passing air through the opening section 25. That is, the optical lens 6 has both the function of controlling light distribution, and function of enhancing the heat dissipation characteristics. By providing the step section 26, an advantage that light guided to the step section 26 is prevented from being made incident on the cover member 14 to be further guided can be obtained. Thereby, it is possible to reduce light loss caused by light guiding.

By arranging the cylinder member 10 in the opening section 25 in contact with the optical lens 6 in an inserting manner, a space surrounding the plurality of light-emitting elements 1 is formed. That is, the space is enclosed by the incidence plane 32, reflection concave 34, and step section 26 of the optical lens 6, part of the inner surface of the cover member 14, surface of the transparent member 12, surface 4a of the base plate 21, and part of the outer circumferential surface of the cylinder member 10. For this reason, the outside air to be introduced through the opening section 25 is prevented from being brought into contact with the light-emitting elements 1, and there is no fear of contaminating the light-emitting elements 1 with dust.

It should be noted that the end section (lower end in FIG. 1 and FIG. 2) of the power supply section 16 on the bulb body side is curved into a spherical shape. Thereby, it is possible to reduce the air resistance caused when the outside air introduced into the inside of the bulb through the cylinder member 10 of the opening section 25, and long cylinder 22 is exhausted through another opening section 27 on the narrowed one end (upper end in FIG. 1 and FIG. 2) side of the cover member 14, smoothly pass the air through the inside of the LED bulb 100, and enhance the heat dissipation performance.

It should be noted that when the LED bulb 100 of this embodiment is used in the posture (posture in which the base 18 is held above) shown in FIG. 1 and FIG. 2, the air warmed by receiving heat from the heat dissipation member 8 goes up inside the long cylinder 22, and is exhausted from the opening section 27. Thereby, the outside air flows in from the opening section 25, and a flow of air passing through the inside of the LED bulb 100 is formed.

### Second Embodiment

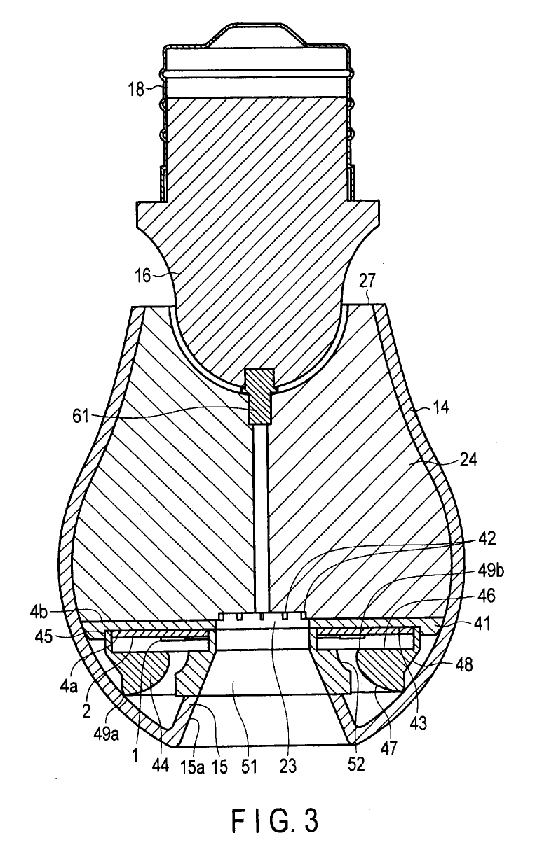

FIG. 3 is a cross-sectional view obtained by cutting an LED bulb 200 according to a second embodiment into halves along a bulb axis thereof. FIG. 3 corresponds to FIG. 2 used in the explanation of the first embodiment. The LED bulb 200 of this embodiment has a structure and function basically identical to the LED bulb 100 of the first embodiment described above.

The LED bulb 200 includes an annular plate-like base member 41 having a surface 4a on which a substrate 2 including a plurality of light-emitting elements 1 mounted thereon in an annular form is arranged in such a manner that the substrate 2 is in contact with the surface 4a. Unlike the base member 4 of the first embodiment, the base member 41 of this embodiment has no configuration corresponding to the long cylinder 22. Instead of the long cylinder 22, the base member 41 includes a plurality of grooves 42 each of which receives part of each of a plurality of fins 24 around a through hole 23 on the back 4b side thereof. Further, the outer circumferential edge of the base member 41 reaches the inner surface of a cover member 14. That is, the LED bulb 200 of this embodiment includes no configuration corresponding to the transparent member 12 of the first embodiment.

On the surface 4a of the base member 41, a concave section 43 configured to accommodate therein the annular substrate 2 on which the plurality of light-emitting elements 1 are mounted is provided. The outer diameter of the concave section 43 is slightly greater than the outer diameter of the substrate 2. Further, in an annular gap between the outer circumferential edge of the concave section 43, and outer circumferential edge of the substrate 2, a cylindrical part 45 protruding from the outer circumferential edge of an optical lens 44 toward the base member 41 is inserted to be arranged therein.

The optical lens 44 includes an incidence plane 46 opposed to the light-emitting elements 1, curved surface 47 continued from the inner edge of the incidence plane 46, and exit plane 48 connecting the outer edge of the incidence plane 46, and outer edge of the curved surface 47 to each other. The exit plane has an inwardly bent shape. The optical lens 44 is in contact with the inner surface of the cover member 14 at the boundary part 49 between the curved surface 47, and exit plane 48.

A cylinder member 51 is approximately cylindrical, and one end (upper end in FIG. 3) thereof abuts on the surface 4a of the base member 41 at a part around a through hole 23. The inner surface of the cylinder member 51 is spread toward the other end (lower end in FIG. 3) side thereof. On the outer surface of the cylinder member 51, a concave annular mirror surface 52 (reflection surface) curved in an arc-like shape is provided. The center of curvature of the mirror surface 52 is the boundary part 49b between the incidence plane 46, and curved surface 47 of the optical lens 44. A gap is provided between the curved surface 47 of the optical lens 44, and mirror surface 52 of the cylinder member 51. That is, the optical lens 44, and the cylinder member 51 are not in contact with each other. Thereby, the optical lens 44, and the cylinder member 51 are separated from each other in terms of heat, and it is possible to prevent the optical lens 44 from being deteriorated by temperature rise. However, the configuration is not limited to this, and the optical lens 44, and the cylinder member 51 may be in contact with each other. When the optical lens 44, and the cylinder member 51 are in contact with each other, it becomes possible to firmly fix the optical lens 44.

The cover member 14 includes a folded part 15 including an inclined surface 15a continued on the inner surface of the cylinder member 51 at the central part near the lower end in FIG. 3. The front end edge of the folded part 15 abuts on the other end (lower end in FIG. 3) of the cylinder member 51. That is, in the space enclosed by part of the inner surface of the cover member 14, inner surface of the folded part 15, outer surface of the cylinder member 51, and surface 4a of the base member 41, the optical lens 44, and the light-emitting elements 1 are arranged. Thereby, in this embodiment too, the light-emitting elements 1 are prevented from being brought into contact with the outside air to be introduced through the inside of the cylinder member 51.

The LED bulb 200 of this embodiment includes no long cylinder of the base member, and hence the outside air introduced into the through hole 23 of the base member through the folded part 15, and cylinder member 51 flows in contact with the plurality of fins 24. Further, the outside air which has flowed through parts between the plurality of fins 24 is exhausted through an annular opening section 27 between the spherical surface of the power supply section 16, and one end (upper end in FIG. 3) of the cover member 14.

It should be noted that between the plurality of fins 24, and power supply section 16, a coupling bolt 61 is provided. This coupling bolt 61 is configured to couple the power supply section 16, and fins 24 to each other by rotating the cover member 14 with respect to the power supply section 16. For this reason, the direction of the thread of the coupling bolt 61 is designed identical to the direction of the thread of the base 18. Thereby, a problem with the power supply section 16, and bulb in their being undesirably separated from each other is not caused when the LED bulb 200 is screwed/inserted into a socket (not shown).

Hereinafter, the function, and advantage of each of the LED bulbs 100, and 200 of the first, and second embodiments described above will be described below in more detail. It should be noted that in the following description, the function, and advantage will be described as a function, and advantage common to the two embodiments except for the case where a function, and advantage inherent in each of the embodiments are described.

The optical lens 6 is constituted of a substance having high transmittance such as polycarbonate (PC), poly-methyl-methacrylate (PMMA), and the like, and converts light emitted from the light-emitting elements 1 having high directivity into widely-distributed light. The optical lens 6 may be rotationally symmetric, and the rotational symmetry axis thereof may coincide with the bulb axis. It is possible that a plurality of optical lenses 6 exist. A plurality of light-emitting elements 1 may be arranged in an annular form. By using a plurality of light-emitting elements 1 different from each other in color temperature, it is possible to impart a light controlling function to the LED bulb 100, and it is also possible to change the emission color of the LED bulb 100.

Assuming that an LED of the surface mount device (SMD) type is used as the light-emitting element 1, and when a plurality of SMD LEDs are arranged in an annular form, the height along the bulb axis of the optical lens 6 is proportional to the dimensions of the light-emitting face of the LED. Although a length of one side of a general LED is 1.5 mm, in this case, the height of the optical lens 6 can be designed to be about 9 mm. The lens height of most of E26 LED bulbs on the market is 30 to 50 mm, and hence according to this embodiment, it is possible to make the dimension of the light-emitting section in the bulb-axis direction smaller, and utilize a more area of the bulb for heat dissipation.

The optical lens 44 of the second embodiment is provided with a cave defined by the curved surface 47, exit plane 48 arranged to surround the cave, and incidence plane 46 opposed to the light-emitting elements 1, and by satisfying the following relationship with respect to an angle θ formed between a straight line drawn from a first point P1 on the incidence plane 46 to a second point P2 on the curved surface 47, and normal at the second point P2, the optical lens 6 guides the light reaching the curved surface 47 to the exit plane 48 by total reflection causing no absorption loss of light.

sin θ1/n

n: a refractive index of the material constituting the lens

That is, the optical lens 6 efficiently guides the light emitted from the light-emitting elements 1 in the lateral direction of the optical lens 6 to thereby cause the light to exit to the outside. As described above, it is possible to provide an optical lens 6 having a high degree of efficiency, and capable of producing widely-distributed light.

Furthermore, the exit plane 48 of the optical lens 6 is provided with an inwardly bent part, whereby the light flux incident on the bent surface is refracted/transmitted in a wide range to be caused to exit, and hence further wider light distribution is enabled. Alternatively, the optical lens 6 is made integral with the inner surface of the cover member 14 without being provided with the exit plane, whereby it is possible to eliminate the layer of air between the optical lens 6, and cover member 14, and reduce the reflection loss. At this time, the cover member 14 is constituted of a surface including an area having a fixed curvature, and hence it is possible to rephrase that the exit plane of the optical lens 6 is made a surface having a fixed curvature.

The curved surface 47 of the optical lens 6 is a streamlined surface not only capable of making light cause total reflection, but also capable of making air smoothly pass through the through hole 23. That is, the optical lens 6 has both the function of controlling light distribution, and function of enhancing the heat dissipation characteristics.

By providing a thermal interface material (TIM) such as heat dissipation grease, thermally-conductive double-sided adhesive tape or the like between the base member 4 (41), and substrate 2, it is also possible to reduce the contact thermal resistance. The base member 4 (41) is formed of a substance having high thermal conductivity such as aluminum or the like. By making the substrate 2 a member independent of the base member 4 (41), it is possible to mount the light-emitting elements 1 on the substrate 2, and subject the base member 4 (41) to machining for producing a complicated shape. The substrate 2 is fixed to the base member 4 (41) by screwing or the like.

The cylinder member 10 (51) is thermally connected to the surface 4a of the base member 4 (41). The cylinder member 10 (51) may be in line contact or in point contact with the optical lens 6. As the cross-sectional shape of the cylinder member 10 (51), various shapes such as a cylindrical shape, polygonal shape, and the like are conceivable. By providing the cylinder member 10 (51) on the air-inflow side, it is possible to provide the heat dissipation surface inside the LED bulb 100 (200). Further, in the first embodiment, the inner surface of the long cylinder 22 of the base member 4 also functions as a heat dissipation surface.

Further, by forming the cylinder member 10 (51) of a material having relatively high thermal conductivity such as a metal or ceramics, it is possible to make the temperature of the part near the air-inflow port high. Thereby, the inflow of the air is facilitated by the chimney effect. Further, as in the case of the first embodiment, when part of the optical lens 6 is exposed to the air-inflow port, it is possible to reduce the pressure loss at the inflow port by curving the exposed part. The curved surface also provides an advantage of guiding light emitted from the light-emitting elements to the inside of the optical lens 6 by making the light cause total reflection. Thereby, it becomes possible to lead light to wide light distribution.

As in the case of the second embodiment shown in FIG. 3, by providing the mirror surface 52 on the outer wall of the cylinder member 51, it is possible to efficiently make the light directed to the mirror surface 52 incident on the curved surface 47 of the optical lens 44. If it is assumed that light beams are emitted from a boundary part 49b of the optical lens 44 present at the center of curvature of the mirror surface 52, all the light beams return to the boundary part 49. In view of this point, light beams emitted from positions above the boundary part 49b in FIG. 3 are reflected from the mirror surface 52 toward the curved surface 47 of the optical lens 44. Thereby, wide light distribution can be realized.

Further, from a different point of view, by making the center of curvature of the mirror surface 52 a point on the curved surface 47 of the optical lens 44, and a point (that is, the boundary part 49b) closest to the light-emitting elements 1, it is possible to eliminate the component of the light emitted from the light-emitting elements 1, and reflected/returned from the mirror surface 52 to the light-emitting elements 1. Thereby, it is possible to enhance the luminous efficiency.

Further, the longer the flow path along which the outside air is made to flow inside the bulb, the more improvement of the heat dissipation performance can be expected by the chimney effect. The pressure difference LP between the inside, and outside of the air-inflow port which is the drive force of the chimney effect can be expressed by the following formula.

$$Δ P = {ρ}_{o} \frac{{T}_{i} - {T}_{o}}{{T}_{i}} gh \qquad [ Math 1 ]$$

Here, ρ is density, T is temperature, g is gravitational acceleration, h is chimney height, index o is outside, and index i is inside. The greater the temperature difference between the inside, and outside or the greater the length of the chimney, the greater the drive force becomes, and hence an advantage can be expected.

The cover member 14 contains therein the base member 4 (41), cylinder member 10 (51), light-emitting elements 1, and fins 24, and further has a shape of a body of revolution formed around the bulb axis. Further, the cover member 14 may have various shapes such as a spherical shape, cylindrical shape, and polygonal shape.

Furthermore, the cover member 14 may have a spherical shape in which part of the cover member 14 has a solid angle 2[Sr] or larger.

When the transparent member 12 is provided as in the case of the first embodiment, the transparent member 12 may be formed integral with the cover member 14. It is desirable that the transparent member 12 be constituted of a substance having high transmittance such as polycarbonate (PC), poly-methyl-methacrylate (PMMA), and the like. However, the light emitted from the light-emitting elements 1 is distributed by the optical lens 6, and hence the cover member 14 may not be formed of a material having a sufficiently high refractive index such as polycarbonate (PC), PMMA, glass, and the like. For example, as the material for the cover member 14, paper such as Japanese paper or the like, and a porous substance such as a kite string or the like may be used, and design appropriate for the use can be employed.

Further, it is possible to use a material having high thermal conductivity such as a metal, ceramics, and the like, or a material having high emissivity as the material for the member outside the range of the ½ light distribution angle of the light made to exit from the optical lens 6 (44) in order to enhance the heat dissipation properties of the LED bulb 100 (200), and it is possible to further enhance the heat dissipation performance.

By providing the exit plane 33 of the optical lens 6 with a step section 26 not in contact with the cover member 14 as in the case of the first embodiment, it is possible to irradiate the inner surface of the cover member 14 with part of the light made to exit from the exit plane 33 through the step section 26. Thereby, it is possible to emit light not directly incident on the cover member 14 in addition to the light to be guided from the end face of the cover member 14 to the inside thereof, and improve the device efficiency. That is, in this case, it is possible to reduce absorption or reflection of the light to be guided inside the thickness of the cover member 14, reduce the absorption loss or the reflection loss, and enhance the luminous efficiency of the LED bulb 100.

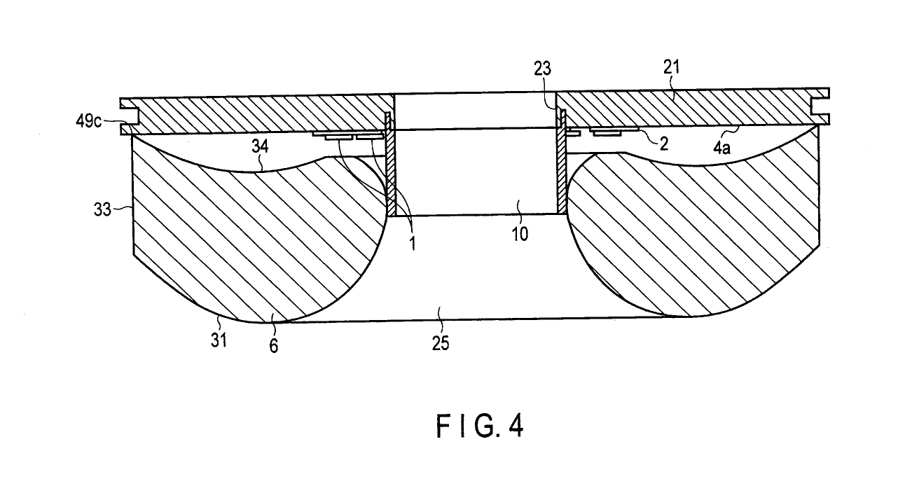

Further, as in the case of each of the embodiments described above, by employing the structure in which the light-emitting elements 1 are covered with the base member 4 (41), optical lens 6 (44), cover member 14, cylinder member 10 (51), and the like, it is possible to prevent the outside air from coming into contact with the light-emitting elements 1, and prevent intrusion of dust or the like from occurring. Further, as shown in, for example, FIG. 4, by making the boundary part 49c between the exit plane 33, and reflection concave 34 of the optical lens 6 in contact with the surface 4a of the base plate 21, too, it is possible to prevent the light-emitting elements 1, reflection concave 34, and incidence plane 32 of the optical lens 6 from coming into contact with the outside air.

As in the case of the first embodiment, by contriving not to provide the base member 4 or the fin 24 within the range of the ½ light distribution angle of the light made to exit from the optical lens 6, it is possible to achieve a high degree of device efficiency. That is, in the first embodiment, by arranging the transparent member 12 between the outer circumferential edge of the base plate 21, and cover member 14, it is possible to guide almost the whole light emitted from the optical lens 6 to the cover member 14.

By the configuration described above, it is possible to impart a heat dissipation function to the base 18 side, and impart a light-emitting function to the light-emitting element 1 side, with the base member 4 (41) serving as a boundary between the base 18 side, and light-emitting element 1 side, separate the area of heat, and area of light from each other, and dissolve the trade-off problem associated with the compatibility of heat dissipation performance with luminescent performance. Thereby, the fins do not act as a shield against light, and hence it is possible to make the fin shape more complicated, and enhance the degree of flexibility in design.

The fin 24 is constituted of a substance having high thermal conductivity such as aluminum or the like. It is possible to enhance the reflectance by making the surface of the fin 24 a mirrored surface. Alternatively, it is also possible to enhance the emissivity by painting the surface of the fin 24. It is also possible to form a hole (holes) or the like in the fin 24. Thereby, even in the case where the LED bulb 100 (200) is fit in a posture in which the bulb axis is held horizontal, it is possible to make the air ascending by natural convection pass through the gap provided between the fins 24, and prevent the heat dissipation performance from being lowered. As the shape of the fin 24, various shapes are conceivable, and flat fins 24 are not necessarily arranged radially.

Further, it is also possible to employ forced air cooling by providing the fins 24 with a rotational mechanism. For example, a rotating shaft along the bulb axis is arranged inside the LED bulb 100 (200), and a plurality of fins 24 are made rotatable with respect to the rotating shaft or a plurality of fins 24 are made rotatable together with the bulb axis, whereby it is possible to form a rapid flow of air inside the bulb, and make the fins 24 efficiently carry out heat dissipation. Further, by increasing the mass flow rate of air inside the bulb, it is possible to lower the temperature of the air near the fins 24. Alternatively, a rotating body such as a fan or the like may be provided near the opening section 27 on the exhaust side, and by adding a function of forced air cooling too, it is possible to increase the radiation amount based on the fins 24. Further, by forming the rotating body itself out of a material having high thermal conductivity such as aluminum or the like, it is also possible to increase the radiation amount from the rotating body.

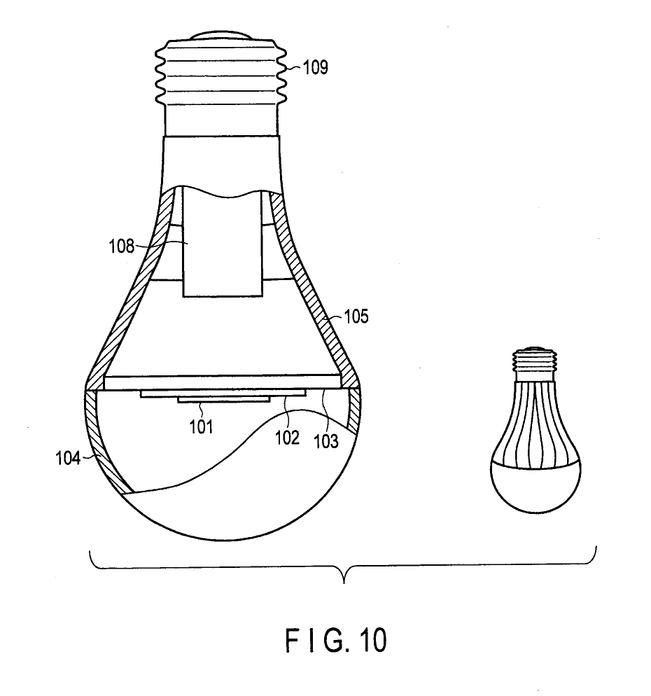

Here, as a comparative example, an example of a conventional LED bulb is shown in FIG. 10. In the LED bulb of the comparative example, almost the whole part of the heat generated from the LEDs 101 is transmitted to the radiator 105 by thermal conduction through the substrate 102, and base 103, and the heat is radiated therefrom into the environment by natural convection, and radiation. It should be noted that in FIG. 10, a reference symbol 104 denotes a cover, a reference symbol 108 denotes a power supply section, and a reference symbol 109 denotes a base of the bulb. In this comparative example, in order to enhance the thermal conductivity, as the material for the base 103, and radiator 105, a metal or ceramics having high thermal conductivity is used. Furthermore, an increase in the transfer amount of the radiation heat is intended by an increase in the heat transfer amount based on the natural convection through expansion (fin structure) of the surface area of the radiator 105 or by enhancement of the emissivity based on specific coating.

Conversely, in this embodiment, heat dissipation is enabled inside the cover member 14, and hence it is possible to achieve the required heat dissipation performance by a small size without exposing the metal or ceramics to the outside. Accordingly, it is possible to more closely approximate the form of an incandescent electric lamp without the need for the part like the radiator 105 of the comparative example.

The power supply section 16 includes a power supply case, and power supply circuit which are not shown, and is placed outside the ½ light distribution angle of the light emitted from the optical lens 6. The power supply circuit is contained in the power supply case, and the power supply case is connected to the base 18 configured to introduce the current from outside. It is also possible to fill the power supply case with resin or heat conduction grease in order to transmit the heat of the power supply circuit to the power supply case. It is desirable that the power supply circuit be not adversely affected by the heat generated from the light-emitting elements 1 by avoiding contact of the power supply section 16 with the base member 4 (41), fins 24, cylinder member 10 (51) or the cover member 14 to the utmost. Furthermore, it is possible to facilitate outflow/inflow of the air from/into the inside of the cover member 14 by forming the power supply case into a shape matching with the shape of the power supply circuit.

Further, in each of the embodiments described above, it is possible to reduce the thermal stress by interposing an elastic body such as an O-ring, silicon or the like between a component formed of resin, and component made of a metal or the like largely different from the resin in linear expansion coefficient.

As has been described above, according to the first, and second embodiments, it becomes possible to provide a LED bulb capable of enhancing the output while securing dust prevention for the light-emitting elements 1, capable of maintaining high luminous efficiency, and capable of preventing the size of the device from becoming large.

### Modification Examples

Hereinafter, modification examples of the above-mentioned embodiments will be described.

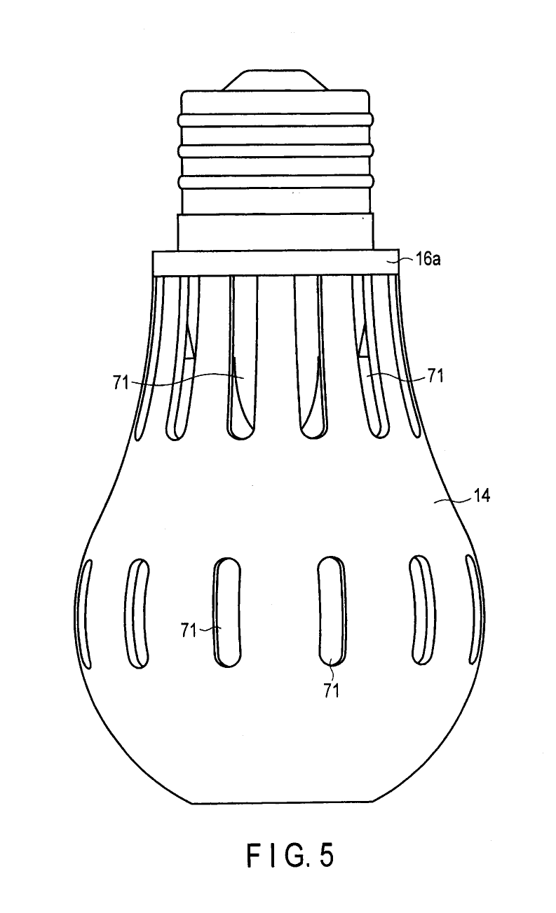

In a first modification example shown in FIG. 5, the cover member 14 is provided with a plurality of ventilation openings 71. Thereby, it is possible to increase the amount (inflow amount, and outflow amount) of air flowing through the inside of the bulb. The positions, size, number, and the like of the ventilation openings 71 are not limited to those shown in the drawing. By forming the openings at positions near the fins 24, it is possible to make the inner structure protective against visual observation, and enhance the heat dissipation performance while maintaining the designability. It should be noted that in the example shown in FIG. 5, the ventilation openings 71 are provided at positions near the end part of the cover member 14 on the power supply section 16 side, and hence the end part of the cover member 14 can be extended to the flange section 16a of the power supply section 16, and the external appearance of the bulb can be improved.

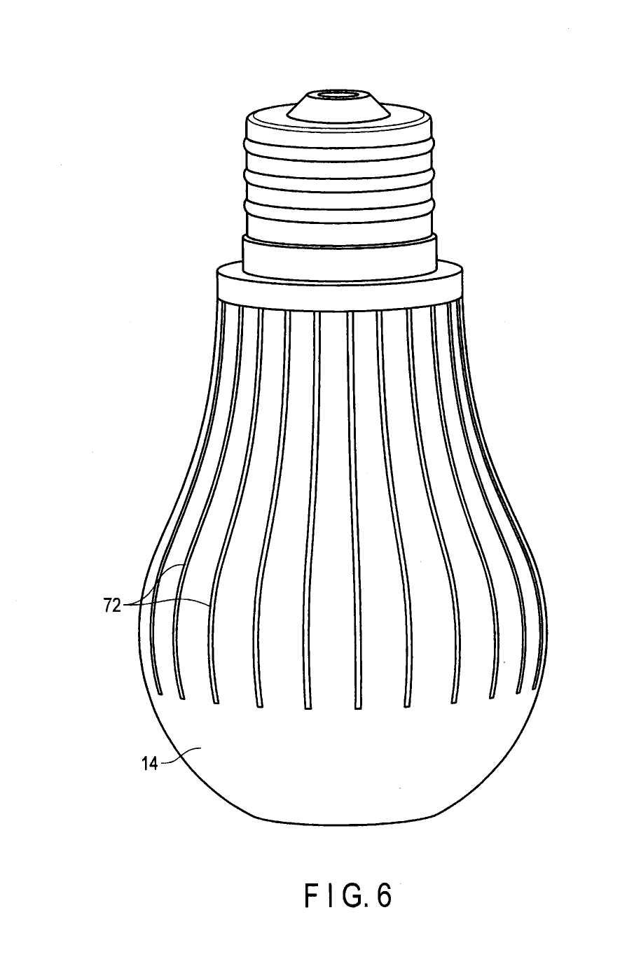

Further, as in the case of a second modification example shown in FIG. 6, by providing the cover member 14 with a plurality of slit-like long and thin ventilation openings 72, it is possible to make the inner structure of the LED bulb harder to see. At this time, by providing the ventilation openings 72 in the vicinities of the fins 24, it is also possible to enhance the heat dissipation performance.

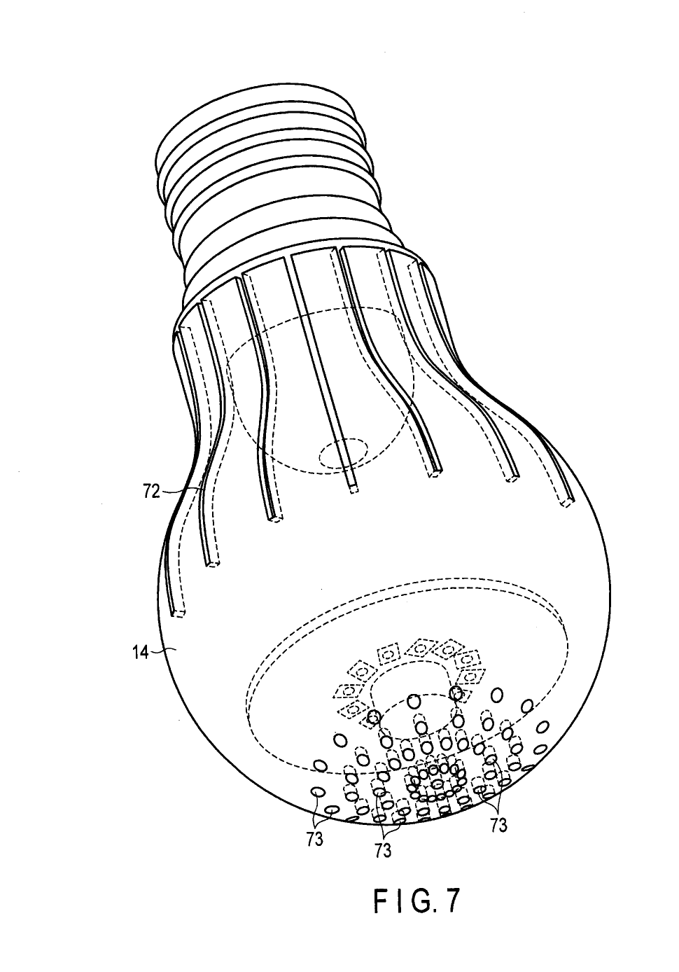

In the first and second embodiments described above, although the outside air is introduced by forming the opening in the center of the cover member 14, the outside air may be introduced by providing a number of holes 73 as in a third modification example shown in FIG. 7 instead of providing the large opening in the center of the cover member 14. In this case, it is possible to prevent an inconvenience such as intrusion of insects into the inside of the cover member 14 from occurring.

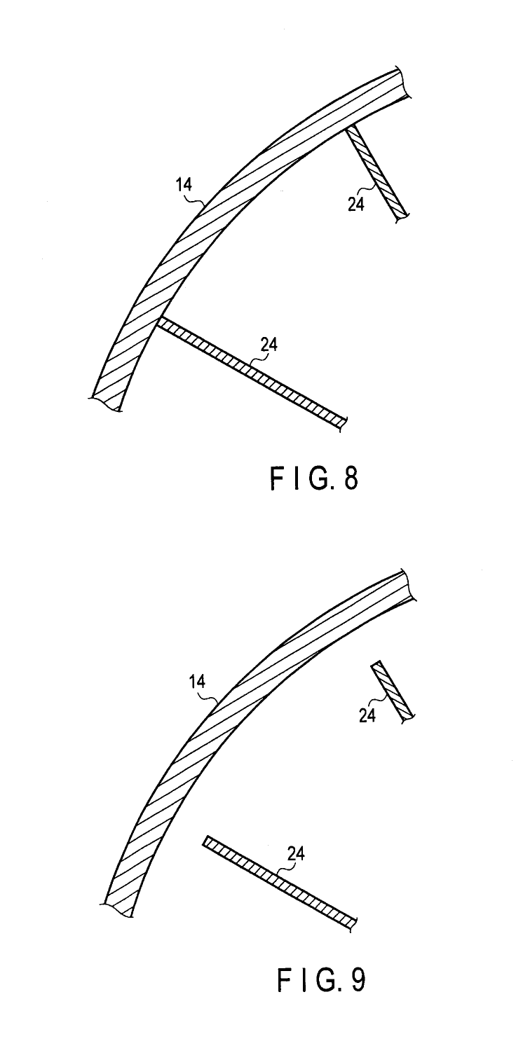

Further, as shown in FIG. 8, it is possible to transmit the heat of the fins 24 to the cover member 14, and enhance the heat dissipation performance by making the plurality of fins 24 in contact with the inner surface of the cover member 14. Alternatively, as shown in FIG. 9, it is possible to make the shadows of the fins 24 hard to see from outside the cover member 14 by providing a gap between the cover member 14 and each of the fins 24.

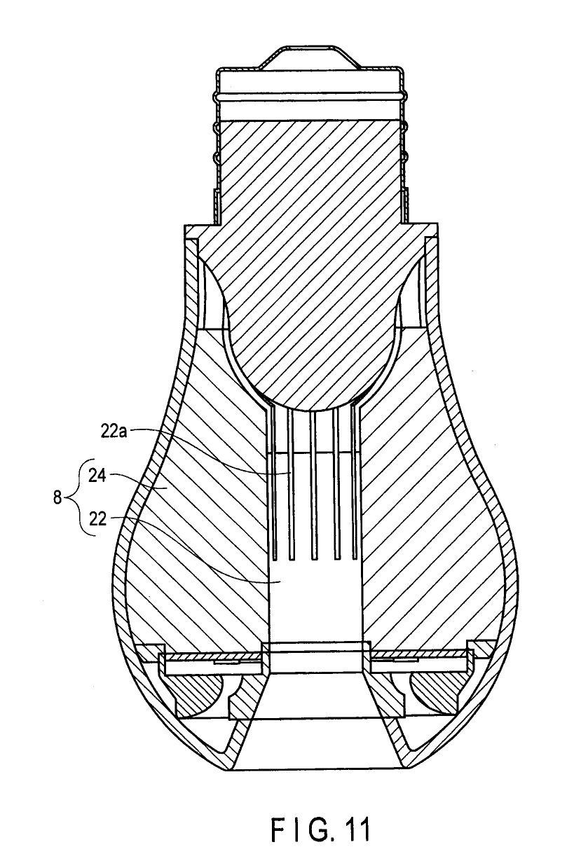

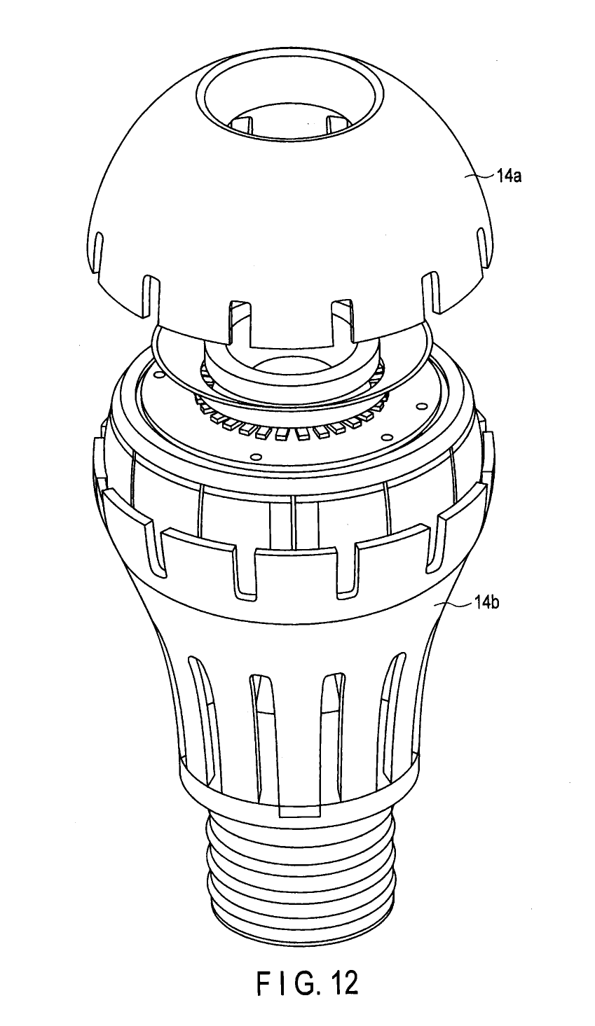

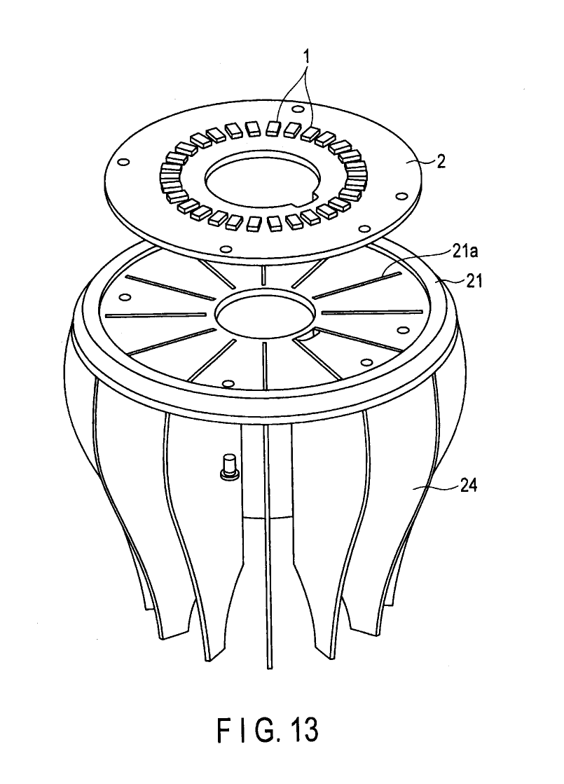

Further, as shown in FIG. 11, in place of the base member 41 of the LED bulb 200 of the second embodiment, a configuration including a long cylinder 22 may be employed. In this case, a plurality of slits 22a configured to accept end edges of the plurality of fins 24 may be provided in the long cylinder 22. Further, as shown in FIG. 13, a plurality of slits 21a configured to accept the other end edges of the plurality of fins 24 may be provided in the base plate 21. Each of the above-mentioned configurations can reduce the contact thermal resistance, and can provide a function of excellently transmit the heat of the fins 24 to the base member. Furthermore, as described above, by providing the base member with the slits 21a, and 22a configured to attach the fins 24 thereto, ease of assembly can be improved. As shown in FIG. 12, by dividing the cover member 14 into pieces in the bulb axis direction, ease of assembly can be improved.

According to the illuminating device of at least one of the embodiments described above, the light-emitting elements 1 are provided on the surface 4a side of the base member 4 (41), and the heat dissipation structure 22, 24 is provided on the back 4b side of the base member 4 (41), and hence it is possible to enhance the luminous efficiency, and make the heat dissipation properties excellent.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above-mentioned embodiment, although an example in which the outside air is introduced through the opening section 25 provided on the cover member 14 side, and is exhausted through the opening section 27 on the opposite side has been described, the example is not limited to this, and when the LED bulb 100 (200) is fit in an inverted position, the flow of air is also inverted. That is, in this case, the outside air introduced through the opening section 27 on the base 18 side is exhausted through the opening section 25 on the cover member 14 side. In either case, sufficient heat dissipation is enabled without lowering the luminescent performance.

1. An illuminating device comprising:
light-emitting elements;
a base member including a first surface on which the light-emitting elements are held, a second surface opposite to the first surface, and a through hole connecting the first surface, and the second surface to each other;
an optical lens arranged to be opposed to the light-emitting elements on the first surface side of the base member, and including a ventilation flue configured to introduce outside air into the through hole; and
a heat dissipation member arranged in thermal contact with the base member on the second surface side of the base member, and configured to come into contact with the outside air to be introduced through the ventilation flue, and the through hole to thereby carry out heat exchange.

2. The device of claim 1, further comprising a cylinder member arranged in the ventilation flue of the optical lens in contact with the first surface of the base member to surround the through hole of the base member.

3. The device of claim 2, wherein
the cylinder member is arranged in contact with an inner surface of the ventilation flue of the optical lens.

4. The device of claim 2, wherein
the cylinder member includes a reflection surface opposed to the optical lens through a gap.

5. The device of claim 1, further comprising a cylinder member configured to guide the outside air to be introduced through the ventilation flue to the through hole in such a manner that the outside air is prevented from coming into contact with the light-emitting elements.

6. The device of claim 1, wherein
the optical lens is rotationally symmetric.

7. The device of claim 6, wherein
the optical lens includes
a cave defined by a curved surface,
an exit plane arranged to surround the cave, and
an incidence plane opposed to the light-emitting elements, and satisfies the following relationship with respect to an angle θ formed between a straight line drawn from a first point on the incidence plane to a second point on the curved surface, and a normal at the second point.
sin θ>1/n
n: a refractive index of a material constituting the lens

8. The device of claim 7, wherein
the exit plane of the optical lens includes a step section.

9. The device of claim 7, wherein
the exit plane of the optical lens is a surface with a fixed curvature.

10. The device of claim 6, wherein
a central axis of the ventilation flue of the optical lens coincides with a symmetry axis of the rotational symmetry.

11. The device of claim 7, wherein
the cylinder member includes a mirror surface, and
a cross section of the mirror surface is a circular arc formed around a third point which is one of points on a curved surface of the optical lens, is closest to the light-emitting elements among the points, and is the center of the circular arc.

12. The device of claim 1, further comprising a cover member containing therein the base member, and the light-emitting elements, wherein
the cover member includes an opening section configured to connect the ventilation flue of the optical lens to the space outside the cover member.

13. The device of claim 1, wherein
the heat dissipation member includes fins thermally connected to the second surface of the base member.

14. The device of claim 1, further comprising:
a base positioned on the second surface side of the base member, and configured to capture power from outside; and
a power supply connected to the base.

15. The device of claim 12, wherein
the base member, and the cover member are connected to each other by a member configured to pass light therethrough.

16. The device of claim 1, wherein
an outer edge of the optical lens is in contact with the first surface of the base member.
